(19) United States
(12) Patent Application Publication
(10) Pub. No.: US 2008/0122898 A1
(43) Pub. Date: May 29, 2008

(54) PATTERN FORMING METHOD AND CIRCUIT BOARD

(75) Inventor: Naoyuki TOYODA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/930,918

(22) Filed: Oct. 31, 2007

(30) Foreign Application Priority Data
Nov. 29, 2006 (JP) 2006-321257

(51) Int. Cl. B41J 2/05

(52) U.S. Cl. 347/56

(57) ABSTRACT

A pattern forming method successively discharges droplets of a functional fluid including a functional material towards a base substrate and forms a pattern on a surface of the base substrate. The pattern forming method comprises heating a surface of the base substrate to a surface temperature equal to or more than a temperature of the functional fluid during discharging and less than a boiling point of a liquid composition included in the functional fluid and, when the base substrate is heated to the surface temperature, discharging the droplets of the functional fluid onto the base substrate and forming a pattern.

### BACKGROUND

1. Technical Field

The present invention relates to a method of forming a pattern and to a circuit board.

2. Related Art

Conventionally, use of a droplet discharging device to discharge a functional fluid as droplets and form a linear pattern on a substrate is known (for example, refer to JP-A-2005-34835).

Generally, the droplet discharging device includes a substrate and a droplet discharging head. The substrate is placed on a stage. The droplet discharging head discharges the functional fluid including a functional material onto the substrate as droplets. The droplet discharging device also includes a mechanism for allowing two-dimensional relative movement between the substrate (stage) and the droplet discharging head. A droplet discharged from the droplet discharging head is arrayed on a substrate surface in an arbitrary position. At this time, each droplet successively arrayed onto the substrate surface is successively arrayed so that a range over which each droplet spreads mutually overlaps. As a result, a linear pattern that is covered with the functional fluid without gaps can be formed on the substrate surface.

When the substrate surface has repellency against the functional fluid, a force of attraction between adjacent droplets caused by surface tension is stronger than a force of attraction between the substrate surface and the functional fluid. Therefore, the functional fluid becomes locally concentrated. When localized concentration such as this occurs, the substrate surface cannot be evenly covered with the functional fluid. In worst case, a portion of the substrate surface is exposed because of lack of functional fluid.

A technology is proposed in which, to print a product number or the like on a component as desired using a droplet discharging device, the component is heated in advance to about 60° Celsius. A solvent in an arrayed droplet dries before the droplet can bleed. As a result, a pattern without bleeding is formed (refer to JP-A-2004-306372).

A following is also proposed. A substrate is heated to a temperature of 60° Celsius. A discharged solvent is quickly dried, and spacers that adjust spacing of liquid crystal elements between substrates are disposed (refer to JP-A-11-281985).

JP-A-2005-34835 is an example of related art. JP-A-2004-306372 is an example of related art. JP-A-11-281985 is an example of related art.

However, JP-A-2004-306372 and JP-A-11-281985 only focus on a drying speed of a droplet that has struck the substrate and do not take into consideration behaviors of the droplet after striking. In other words, when a substrate temperature is high, bumping of the droplet that has struck occurs simultaneously with impact and the pattern is not formed on the substrate. This is a problem in terms of formation of a wiring pattern requiring high-density and high-resolution pattern formation.

Because discharging timing of each successively arrayed droplet is not taken into consideration, in some cases, the force of attraction between the droplets caused by surface tension is still strong and the functional fluid becomes locally concentrated. This is a problem in terms of formation of a wiring pattern requiring high-resolution pattern formation.

### SUMMARY

The present invention has been achieved to solve the problems described above. An advantage of the present invention is to provide a pattern forming method and a circuit board in which the pattern forming method can allow formation of a high-density and high-resolution pattern within a short period of time.

A pattern forming method according to an aspect of the invention is a method in which droplets of a functional fluid including a functional material are successively discharged towards a base substrate and a pattern is formed on a surface of the base substrate. The pattern forming method includes two procedures. In a first procedure, a surface of the base substrate is heated to a surface temperature equal to or more than a temperature of the functional fluid during discharging and less than a boiling point of a liquid composition included in the functional fluid. In a second procedure, when the base substrate is heated to the surface temperature, the droplets of the functional fluid are discharged onto the base substrate and the pattern is formed.

According to the pattern forming method of the invention, the droplet that has struck the base substrate is immediately dried without bumping. As a result, a high-density and high-resolution pattern can be formed within a short period of time.

In the pattern forming method, a preferred aspect of the invention is that, in the first procedure, the base substrate is heated to a surface temperature at which a concentration of solid matter (particles) in an outer periphery of the droplet that has struck the base substrate reaches a saturated concentration more quickly, compared to a center of the droplet.

According to the pattern forming method, a preceding droplet is fixed onto the base substrate from the outer periphery. Therefore, an outer shape of the preceding droplet at impact does not change. As a result, a high-density and high-resolution pattern can be formed.

In the pattern forming method, a preferred aspect of the invention is that the pattern formed through the second procedure is formed by droplets being discharged such that adjacent droplets that have struck the base substrate at least partially overlap with each other.

According to the pattern forming method, consecutive high-density and high-resolution patterns can be formed within a short period of time.

In the pattern forming method, a preferred aspect of the invention is that, when a droplet is discharged such as to partially overlap with a droplet that has struck the base substrate first, the droplet is discharged after an outer diameter of the droplet that has struck the base substrate first stops changing.

According to the pattern forming method, the preceding droplet is fixed onto the base substrate and is not pulled towards the next droplet.

In the pattern forming method, a preferred aspect of the invention is that, in the second procedure, a time required until the outer diameter of the droplet that has struck stops changing, for the surface temperature, is determined in advance. The determined time serves as an interval of discharging the droplets. The droplets are successively discharged at an interval greater than the discharging interval time.

According to the pattern forming method, the next droplet is discharged after the droplet is fixed onto the base substrate with certainty. Therefore, the droplets do not attract and the shape of the pattern is not affected.

In the pattern forming method, a preferred aspect of the invention is that the base substrate is a low-temperature firing sheet composed of ceramic particles and resin. The functional fluid is a liquid in which metal particles are dispersed as functional material.

According to the pattern forming method, a pattern made from metal film can be formed on a porous substrate.

In the pattern forming method, a preferred aspect of the invention is that the boiling point of the liquid composition included in the functional fluid is the boiling point of a liquid composition with the lowest boiling point among the liquid compositions.

According to the pattern forming method, the droplet can be dried with certainty without bumping occurring on the base substrate.

In the pattern forming method, a preferred aspect of the invention is that the boiling point of the liquid composition included in the functional fluid is the boiling point of a liquid composition with the lowest boiling point among liquid compositions having a concentration that affects pattern formation when bumping occurs.

According to the pattern forming method, the droplet can be dried more optimally and more efficiently.

A circuit board according to an aspect of the invention is a circuit board on which a circuit element is mounted and on which wiring electrically connected to the mounted circuit element is formed. In the circuit board, the wiring is formed using the pattern forming method according to above aspects of the invention

According to the circuit board of the invention, productivity can be increased.

### BRIEF DESCRIPTION OF THE DRAWINGS

The invention will be described with reference to the accompanying drawings, wherein like numbers reference like elements.

FIG. 1 is a cross-sectional side view of a circuit module.

FIG. 2 is an overall perspective view of a droplet discharging device.

FIG. 3 is a bottom view of a droplet discharging head viewed from a green sheet side.

FIG. 4 is a cross-sectional side view of principal sections of the droplet discharging head.

FIG. 5 is an electrical circuit block diagram explaining an electrical configuration of the droplet discharging device.

FIG. 6A to FIG. 6E are diagrams explaining behaviors of a droplet that has struck the green sheet; FIG. 6A is a diagram of a shape of the droplet immediately after impact; FIG. 6B is a diagram of a shape of the droplet when the droplet spreads outwards while drying; FIG. 6C is a diagram of a shape of the droplet when the droplet becomes fixed onto the green sheet; FIG. 6D is a diagram of a shape of the droplet when the droplet becomes fixed and dries in a thickness direction; and FIG. 6E is a diagram of a shape of the droplet when the droplet is dried.

FIG. 7 is a diagram explaining a process of pattern formation.

FIG. 8A to FIG. 8D are diagrams of a droplet discharging sequence for pattern formation.

FIG. 9A and FIG. 9B are diagrams of wiring patterns formed by droplets of metallic ink, in which a solvent is tetradecane, being discharged onto a glass substrate. FIG. 9A and FIG. 9B are diagrams of wiring patterns that are each formed when changes are made to conditions such as a temperature of the glass substrate and a discharging interval time.

FIG. 10A and FIG. 10B are diagrams of wiring patterns formed by droplets of metallic ink, in which a solvent is tetradecane, being discharged onto a glass substrate. FIG. 10A and FIG. 10B are diagrams of wiring patterns that are each formed when changes are made to conditions such as a temperature of the glass substrate and a discharging interval time.

FIG. 11A and FIG. 11B are diagrams of wiring patterns formed by droplets of metallic ink, in which a solvent is tetradecane, being discharged onto a glass substrate. FIG. 11A and FIG. 11B are diagrams of wiring patterns that are each formed when changes are made to conditions such as a temperature of the glass substrate and a discharging interval time.

FIG. 12A to FIG. 12F are diagrams of a pattern formation performed in another sequence.

### DESCRIPTION OF EXEMPLARY EMBODIMENTS

Embodiments of the present invention will be described.

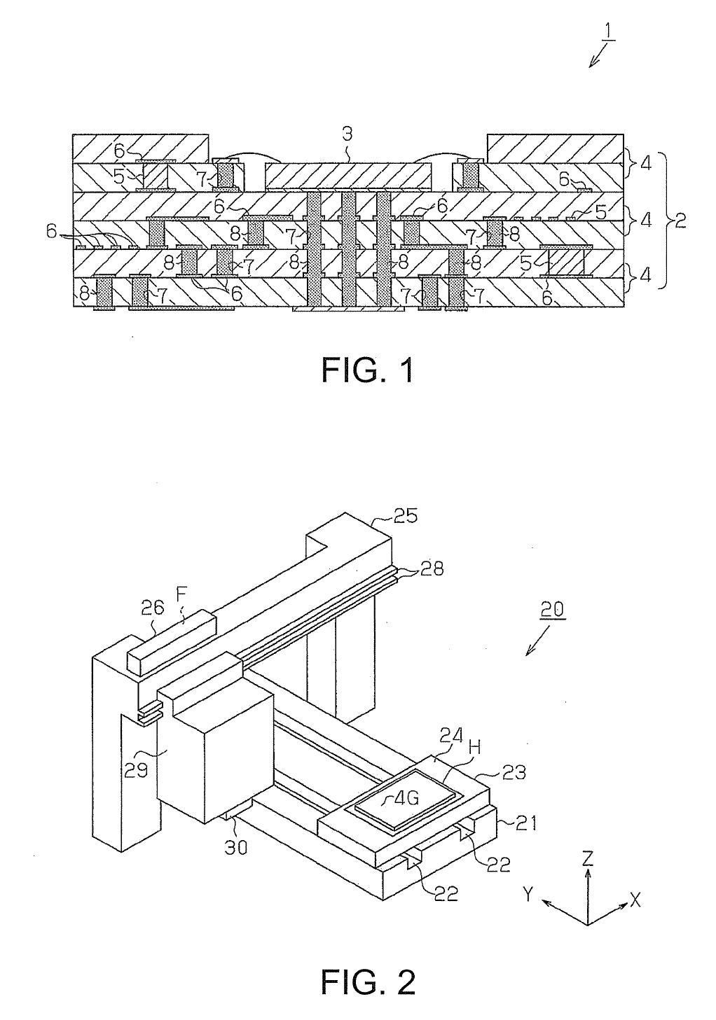

An embodiment of the invention will be below described, with reference to FIG. 1 to FIG. 7. The invention according to the embodiment is a circuit module formed by a semiconductor chip being mounted on a low-temperature co-fired ceramic (LTCC) multilayer substrate. The invention according to the embodiment is realized through a formation of a wiring pattern drawn on a plurality of low-temperature fired substrates (green sheets) forming the LTCC multilayer substrate.

First, the circuit module formed by the semiconductor chip being mounted on the LTCC multilayer substrate will be described. FIG. 1 is a cross-sectional view of a circuit module 1. The circuit module 1 includes a LTCC multilayer substrate 2 and a semiconductor chip 3. The LTCC multilayer substrate 2 is formed into a board. The semiconductor chip 3 is connected to an upper side of the LTCC multilayer substrate 2 by wire-bonding.

The LTCC multilayer substrate 2 is a stack of a plurality of low-temperature fired substrates 4 that are formed into sheets. Each low-temperature fired substrate 4 is a sintered body formed from glass ceramic material (for example, a composition of glass component such as borosilicic acid alkali oxide and ceramic component such as aluminum oxide). Thickness of each low-temperature fired substrate 4 is several hundred micrometers.

In each low-temperature fired substrate 4, various circuit elements 5, an internal wiring 6, a plurality of via holes 7, and a via wiring 8 are each formed accordingly, based on circuit design. The various circuit elements 5 include a resistive element, a capacitive element, a coil element, and the like. The internal wiring 6 electrically connects each circuit element 5. The via holes 7 have a predetermined hole diameter (such as 20 micrometers) and take on a stack-via structure or a thermal-via structure. The via wiring 8 fills the via holes 7.

Each internal wiring 6 of each low-temperature fired substrate 4 is a sintered body formed from metal microparticles, such as silver and silver alloys. The internal wirings 6 are formed by a wiring pattern forming method using a droplet discharging device 20 shown in FIG. 2.

FIG. 2 is an overall perspective view of the droplet discharging device 20.

In FIG. 2, the droplet discharging device 20 includes a base 21 that is formed into a rectangle. A pair of guiding grooves 22 is formed on the upper surface of the base 21, extending along a longitudinal direction (an arrow Y direction) of the base 21. A stage 23 is provided above the guiding grooves 22. The stage 23 moves along the guiding grooves 22 in the arrow Y direction and a counter-arrow Y direction. A placing section 24 is formed on the upper surface of the stage 23. The low-temperature fired substrate 4 before being fired (referred to, hereinafter, as simply a green sheet 4G) is placed on the placing section 24. The placing section 24 positions the placed green sheet 4G on the stage 23 and fixes the positioned green sheet 4G. The placing section 24 carries the green sheet 4G in the arrow Y direction and the counter-arrow Y direction. A rubber heater H is set on the upper surface of the stage 23. The entire upper surface of the green sheet 4G placed on the placing section 24 is heated to a predetermined temperature by the rubber heater H.

A gate-shaped guiding component 25 is erected over the base 21. The guiding component 25 straddles the base 21 in a direction (an arrow X direction) perpendicular to the arrow Y direction. An ink tank 26 is set on the upper side of the guiding component 25 such as to extend in the arrow X direction. The ink tank 26 stores metallic ink F that serves as a functional fluid. The ink tank 26 supplies a droplet discharging head (referred to, hereinafter, as simply a discharging head) 30 with the stored metallic ink F by applying predetermined pressure. The metallic ink F supplied to the discharging head 30 becomes a droplet Fb (preceding droplet Fb) (see FIG. 4). The droplet Fb is discharged from the discharging head 30 towards the green sheet 4G.

Dispersed metallic ink can be used as the metallic ink F. In the dispersed metallic ink, metal particles serving as a functional material, such as metal microparticles having a particle diameter of several nanometers and serving as the functional material, are dispersed within a solvent. For example, gold (Au), silver (Ag), copper (Cu), aluminum (Al), palladium (Pd), manganese (Mn), titanium (Ti), tantalum (Ta) and nickel (Ni) are used as the metal microparticles used in the metallic ink F. In addition to these materials, oxides of these materials, superconducting microparticles, and the like are used. The particle diameter of the metal microparticle is preferably equal to or more than 1 nanometer and equal to or less than 0.1 micrometers. When the particle diameter is greater than 0.1 micrometers, a discharging nozzle N of the discharging head 30 may become clogged. When the particle diameter is less than 1 nanometer, a volume ratio of the metal microparticles to a dispersing agent increases. The percentage of organic matter within an acquired film becomes excessive.

Carrier fluid is not particularly limited so long as the metal microparticles described above can be dispersed and aggregation does not occur. In addition to aqueous solvents, alcohols, hydrocarbon compounds, polyols, ether compounds, and polar compounds can be given as examples. Alcohols are, for example, methanol, ethanol, propanol, and butanol. Hydrocarbon compounds are, for example, n-heptane, n-octane, decane, dodecane, tetradecane, toluene, xylene, cymene, durene, indene, dipentene, tetrahydronaphthalene, decahydronaphthalene, and cyclohexylbenzene. Polyols are, for example, ethylene glycol, diethylene glycol, triethylene glycol, glycerol, and 1,3-propanediol. Ether compounds are, for example, polyethylene glycol, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis(2-methoxyethyl)ether, and p-dioxane. Polar compounds are, for example, propylene carbonate, y-butyrolactone, N-methyl-2-pyrrolidone, dimethylformamide, dimethyl sulfoxide, cyclohexanone, and ethyl lactate. Among these, in terms of microparticle dispersion, dispersing liquid stability, and easiness of application to the droplet discharging method, water, alcohols, hydrocarbon compounds, and ether compounds are preferable. More preferably, the carrier fluid is water or hydrocarbon compounds.

For example, a metallic ink F can be considered in which silver (Ag) particles are dispersed in an aqueous solvent composed of 40 percent water (boiling point of 100° Celsius), 40 percent ethylene glycol (boiling point of 198° Celsius), and 30 percent polyethylene glycol #1000 (decomposition temperature of 168° Celsius). A metallic ink F can also be considered in which the metal microparticles (particles of Au, Ag, Ni, Mn, and the like) are dispersed in a solvent composed of tetradecane (boiling point of 253° Celsius).

When the droplet Fb of the metallic ink F is heated, a portion of the solvent or the carrier fluid is evaporated and the outer edge of the surface of the droplet Fb thickens. In other words, the concentration of solid matter (particles) in the outer periphery of the droplet Fb reaches a saturated concentration more quickly, compared to the center. Therefore, the droplet Fb thickens from the outer edge of the surface. The metallic ink F having the thickened outer edge stops itself from spreading along a surface direction of the green sheet 4G (performs pinning).

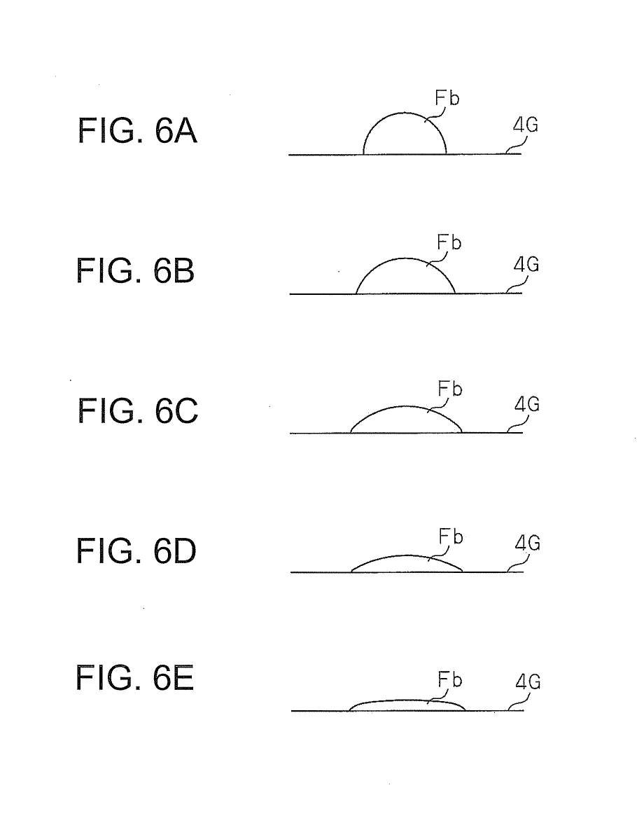

FIG. 6A to FIG. 6E are diagrams explaining behaviors of the droplet Fb that has struck the green sheet 4G until the droplet Fb is dried and fixed onto the green sheet 4G. The droplet Fb that has struck gradually spreads while drying, as shown in FIG. 6B, from a half-spherical shape taken immediately after impact shown in FIG. 6A. At this time, the droplet Fb spreads while the solvent evaporates and the outer edge of the surface thickens. The viscosity further increases. The spread of the droplet Fb stops, as shown in FIG. 6C. As shown in FIG. 6D and FIG. 6E, the dryness of the droplet Fb in the thickness direction subsequently becomes more noticeable.

The metallic ink F that has been pinned, shown in FIG. 6C, is fixed onto the green sheet 4G. The outer diameter of the droplet Fb does not change. Therefore, even when the metallic ink F is overlapped, the droplet Fb is not pulled toward a following droplet Fb.

A pair of upper and lower guiding rails 28 is formed on the guiding component 25 over roughly the entire width of the guiding component 25 in the arrow X direction. The pair of upper and lower guiding rails 28 extends in the arrow X direction. A carriage 29 is attached to the pair of upper and lower guiding rails 28. The carriage 29 is guided by the guiding rails 28 and moves in the arrow X direction and a counter-arrow X direction. The droplet discharging head 30 is installed in the carriage 29.

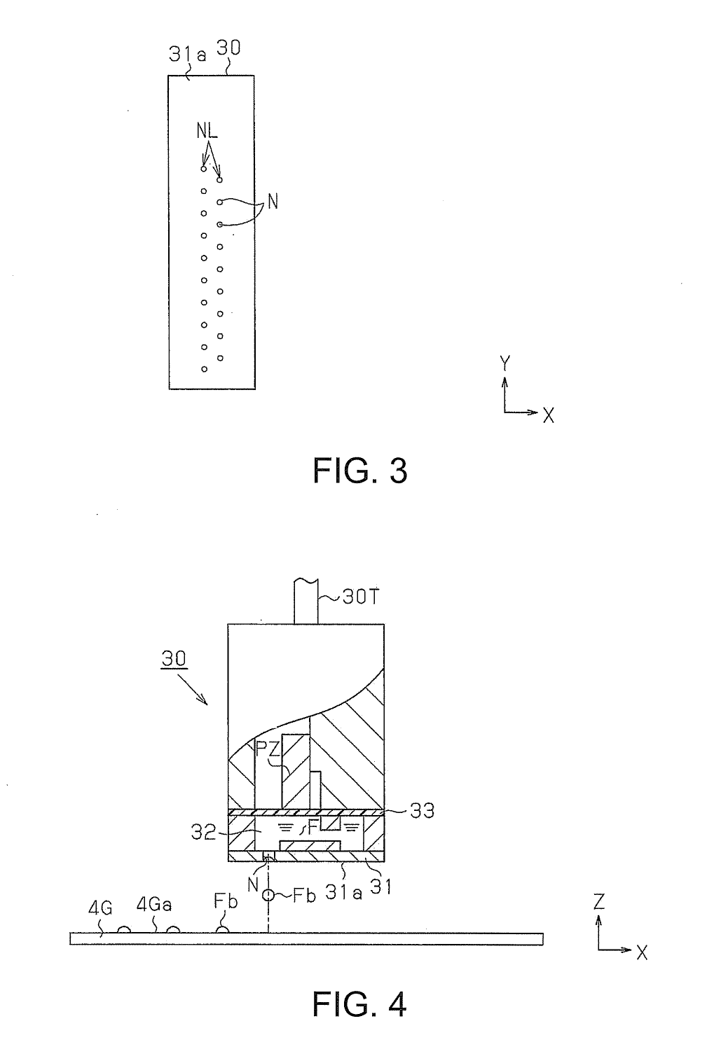

FIG. 3 is a diagram of the discharging head 30 viewed from the green sheet 4G side. FIG. 4 is a cross-sectional view of the principal sections of the discharging head 30. A nozzle plate 31 is provided on the bottom side of the discharging head 30. The bottom surface (a nozzle forming surface 31a) of the nozzle plate 31 is formed roughly parallel with the upper surface (a discharging surface 4Ga) of the green sheet 4G. When the green sheet 4G is positioned directly below the discharging head 30, a predetermined distance (such as 600 micrometers) is maintained between the nozzle forming surface 31a and the discharging surface 4Ga.

In FIG. 3, a pair of nozzle lines NL is formed on the bottom surface (the nozzle forming surface 31a) of the nozzle plate 31. The pair of nozzle lines NL is composed of a plurality of nozzles N aligned along the arrow Y direction. One hundred and eighty nozzles N per inch are formed in each nozzle line NL in the pair of nozzle lines NL. In FIG. 3, only 10 nozzles N per line are shown for purpose of explanation.

When the pair of nozzle lines NL is viewed from the arrow Y direction, each nozzle N in one nozzle line NL interpolates between each nozzle N in the other nozzle layer N. In other words, the discharging head 30 includes 180 nozzles times 2 or, in other words, 360 nozzles N per inch in the arrow Y direction (maximum resolution is 360 dpi).

In FIG. 4, a supply tube 30T serving as a passage is connected to the upper side of the discharging head 30. The supply tube 30T is set extending in an arrow Z direction. The supply tube 30T supplies the discharging head 30 with the metallic ink F from the ink tank 26.

A cavity 32 communicating with the supply tube 30T is formed on the upper side of each nozzle N. The cavity 32 stores the metallic ink F from the supply tube 30T and supplies the corresponding nozzle N with the metallic ink F. A diaphragm 33 is adhered to the upper side of the cavity 32. The diaphragm 33 vibrates in a vertical direction and increases and decreases the volume within the cavity 32. A piezoelectric element PZ corresponding to the nozzle N is set on the upper side of the diaphragm 33. The piezoelectric element PZ contracts and expands in the vertical direction and vibrates the diaphragm 33 in the vertical direction. The diaphragm 33 that vibrates in the vertical direction forms the metallic ink F into the droplet Fb of a predetermined size and discharges the droplet Fb from the corresponding nozzle N. The discharged droplet Fb flies from the corresponding nozzle N in a counter-arrow Z direction and strikes the discharging surface 4Ga of the green sheet 4G.

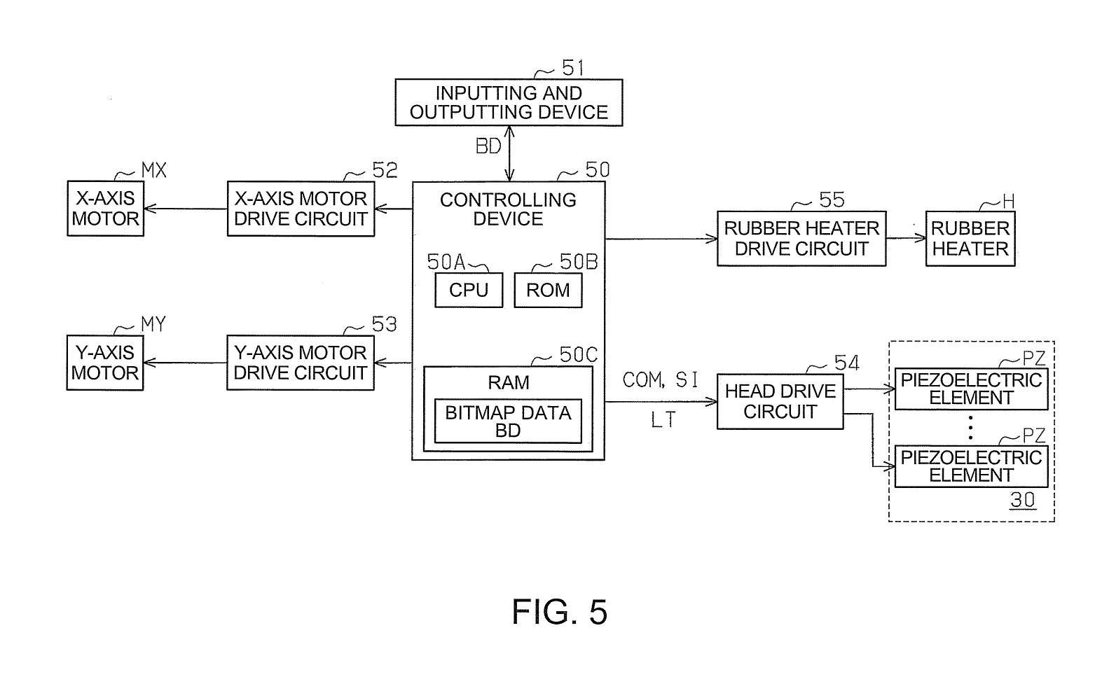

An electrical configuration of the droplet discharging device 20 configured as described above will be described with reference to FIG. 5.

In FIG. 5, a controlling device 50 includes a central processing unit (CPU) 50A, a read-only memory (ROM) 50B, a random-access memory (RAM) 50C, and the like. The controlling device 50 performs a process for carrying the stage 23, a process for carrying the carriage 29, a process for discharging droplets from the discharging head 30, a process for heating the rubber heater H, and the like in accordance with various pieces of data and various control programs that are stored in the controlling device 50.

An inputting and outputting device 51 including various operating switches and a display is connected to the controlling device 50. The inputting and outputting device 51 displays processing states of the various processes performed by the droplet discharging device 20. The inputting and outputting device 51 generates bitmap data (wiring bitmap data BD) used to form the internal wiring 6. The inputting and outputting device 51 then inputs the generated bitmap data BD into the controlling device 50.

The bitmap data BD sets ON and OFF of each piezoelectric element PZ based on a value of each bit (0 or 1). The bitmap data BD establishes whether the droplet Fb for wiring is discharged onto each position on a drawing plane (the discharging surface 4Ga) over which the discharging head 30 (each nozzle N) passes. In other words, the bitmap data BD is used to enable the droplet Fb for wiring to be discharged onto the discharging surface 4Ga at an established target position for forming the internal wiring 6.

An X-axis motor drive circuit 52 is connected to the controlling device 50. The controlling device 50 outputs a drive controlling signal to the X-axis motor drive circuit 52. The X-axis motor drive circuit 52 drives an X-axis motor MX forward or in reverse in response to the drive controlling signal outputted from the controlling device 50. The X-axis motor MX is used to move the carriage 29. A Y-axis motor drive circuit 53 is connected to the controlling device 50. The controlling device 50 outputs a drive controlling signal to the Y-axis motor drive circuit 53. The Y-axis motor drive circuit 53 drives a Y-axis motor MY forward or in reverse in response to the drive controlling signal outputted from the controlling device 50. The Y-axis motor MY is used to move the stage 23.

A head drive circuit 54 is connected to the controlling device 50. The controlling device 50 outputs a discharging timing signal LT to the head drive circuit 54. The discharging timing signal LT is synchronous with a predetermined discharging frequency. The controlling device 50 synchronizes a drive voltage COM with the discharging frequency and outputs the drive voltage COM to the head drive circuit 54. The drive voltage COM is used to drive each piezoelectric element PZ.

The controlling device 50 generates a pattern formation controlling signal SI using the bitmap data BD. The pattern formation controlling signal SI is synchronous with a predetermined frequency. The controlling device 50 serially transfers the pattern formation controlling signal SI to the head drive circuit 54. The head drive circuit 54 successively performs serial-to-parallel conversion on the pattern formation controlling signal SI in correspondence with each piezoelectric element PZ. The head drive circuit 54 latches the pattern formation controlling signal SI to which the serial-to-parallel conversion has been performed every time the discharging timing signal LT is received from the controlling device 50. The head drive circuit 54 then supplies the drive voltage COM to each piezoelectric element PZ selected by the pattern formation controlling signal SI.

A rubber heater drive circuit 55 is connected to the controlling device 50. The controlling device 50 outputs a drive controlling signal to the rubber heater drive circuit 55. The rubber heater drive circuit 55 drives the rubber heater H and controls the rubber heater H to heat the green sheet 4G, placed on the stage 23, to a predetermined temperature in response to the drive controlling signal received from the controlling device 50. According to the embodiment, the predetermined temperature of the green sheet 4G is regulated at a temperature equal to or more than the temperature of the metallic ink F when the metallic ink F is discharged from the discharging head 30 and less than a boiling point of a liquid composition included in the metallic ink F (less than the lowest boiling point temperature among the liquid compositions). In other words, the green sheet 4G is heated to a temperature equal to or more than the temperature of the metallic ink F when the metallic ink F is discharged from the discharging head 30. The droplet Fb that has struck the green sheet 4G is quickly heated and dried. The droplet Fb is not dried by the discharging head 30 during discharging. The green sheet 4G is heated to a temperature less than the boiling point of the droplet Fb. Therefore, bumping of the droplet Fb that has struck does not occur on the green sheet 4G.

For example, when the discharging head 30 is at a room temperature of 27° Celsius and the metallic ink F is silver (Ag) particles dispersed in an aqueous solvent composed of 40 percent water, 40 percent ethylene glycol, and 30 percent polyethylene glycol, the boiling point of water, 100° Celsius, is the lowest. Therefore, the temperature of the green sheet 4G is regulated at 27° Celsius or more and less than 100° Celsius. When the metallic ink F is silver (Ag) particles dispersed in a solvent composed of tetradecane, the boiling point of tetradecane is 253° Celsius. Therefore, if other solvents are not included, the temperature of the green sheet 4G is regulated at 27° Celsius or more and less than 253° Celsius.

Next, a method of forming a wiring pattern on the green sheet 4G using the droplet discharging device 20 will be described.

As shown in FIG. 2, the green sheet 4G is placed on the stage 23 so that the discharging surface 4Ga is facing upwards. At this time, the stage 23 disposes the green sheet 4G in a counter-arrow Y direction from the carriage 29. The via holes 7 are formed on the green sheet 4G. The via wiring 8 is laid through the via holes 7, thereby forming the internal wiring 6 of the discharging surface 4Ga.

From this state, the inputting and outputting device 51 inputs the bitmap data BD into the controlling device 50. The bitmap data BD is used to form the wiring pattern of the internal wiring 6 using the droplets Fb. The controlling device 50 stores the bitmap data BD used to form the internal wiring 6, outputted from the inputting and outputting device 51. At this time, the controlling device 50 drives the rubber heater H provided on the stage 23, via the rubber heater drive circuit 55. The controlling device 50 controls the rubber heater H such that the entire green sheet 4G, placed on the stage 23, is uniformly heated to a predetermined temperature. In other words, the green sheet 4G is regulated at a temperature equal to or more than the temperature of the metallic ink F when the metallic ink F is discharged from the discharging head 30 and less than the boiling point of the liquid composition included in the metallic ink F (less than the lowest boiling point temperature among the liquid compositions).

For example, when the discharging head 30 is at a room temperature of 27° Celsius and the metallic ink F is silver (Ag) particles dispersed in an aqueous solvent composed of 40 percent water, 40 percent ethylene glycol, and 30 percent polyethylene glycol, the boiling point of water, 100° Celsius is the lowest. Therefore, the temperature of the green sheet 4G is regulated at 27° Celsius or more and less than 100° Celsius. When the metallic ink F is silver (Ag) particles dispersed in a solvent composed of tetradecane, the boiling point of tetradecane is 253° Celsius. Therefore, if other solvents are not included, the temperature of the green sheet 4G is regulated at 27° Celsius or more and less than 253° Celsius.

Next, the controlling device 50 drives the Y-axis motor Y, via the Y-axis motor drive circuit 53. The controlling device 50 carries the stage 23 such that the discharging head 30 passes directly over a predetermined position on the green sheet 4G in the arrow X direction. The controlling device 50 then drives the X-axis motor MX, via the X-axis motor driving circuit 52, and starts a discharging head 30 scan (reciprocation).

When the discharging head 30 scan is started, the controlling device 50 generates the pattern formation controlling signal SI based on the bitmap data BD. The controlling device 50 outputs the pattern formation controlling signal SI and the drive voltage COM to the head drive circuit 54. In other words, the controlling device 50 drives and controls each piezoelectric element PZ, via the head drive circuit 54. The controlling device 50 enables the discharging head 30 to discharge the droplet Fb from a selected nozzle N every time the discharging head 30 is positioned over an impact position used to form the internal wiring 6.

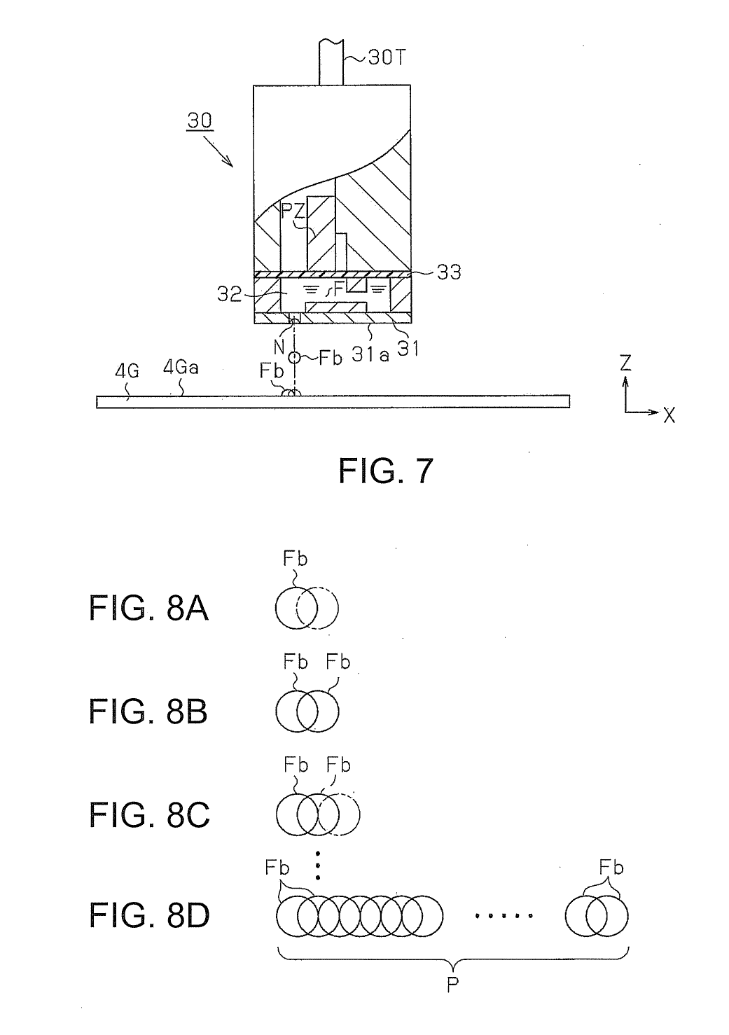

According to the embodiment, as shown in FIG. 7 and FIG. 8A to FIG. 8D, the discharged droplets Fb successively strike corresponding impact positions used to form the internal wiring 6.

Specifically, according to the embodiment, the droplet Fb that strikes the green sheet 4G and is arrayed on the green sheet 4G to form the pattern first partially dries. The droplet Fb is fixed (pinned) onto the green sheet 4G as shown in FIG. 6C (a state in which the droplet Fb has stopped spreading). The next droplet Fb that is discharged from the discharging head 30 and strikes the green sheet 4G is discharged from the discharging head 30 at a position indicated by a dashed line in FIG. 7 and FIG. 8A, such as to partially overlap with the preceding droplet Fb.

In other words, a discharging timing of the droplet Fb discharged from the discharging head 30 is determined by a time required for the droplet Fb to be discharged from the discharging head 30 and fixed (pinned) onto the green sheet 4G. The discharging timing is also determined by a traveling time required for the discharging head 30 to reach a discharging position at which a portion of the next droplet Fb overlaps with the preceding droplet Fb, after the preceding droplet Fb is discharged, and the like. Therefore, the discharging timing is set in advance though experiments and the like, based on the heating temperature of the green sheet 4G, traveling speed of the discharging head 30, and the like.

The time required from impact until the droplet Fb is fixed was determined through experiments. In the experiments, when the metallic ink F is silver (Ag) particles dispersed in a solvent composed of tetradecane, droplet weight per droplet was 5 nanograms. The green sheet 4G was respectively set to a room temperature of 27° Celsius (in other words, the temperature of the metallic ink F when the metallic ink F is discharged from the discharging head 30), 150° Celsius, and 200° Celsius.

As a result, when the green sheet 4G was at room temperature (270 Celsius), 3000 microseconds were required until the droplet Fb was fixed. When the green sheet 4G was 150° Celsius, 495 microseconds were required. When the green sheet 4G was 200° Celsius, 330 microseconds were required. Therefore, it is clear that the time required until the droplet Fb is fixed is significantly shorter when the green sheet 4G is heated to a temperature less than the boiling point, compared to when the green sheet 4G is at a room temperature of 27° Celsius.

As a result, in this case, the discharging timing (a discharging interval timing) is set based on 469 microseconds when the temperature of the green sheet 4G is 150° Celsius and 330 microseconds when the temperature of the green sheet 4G is 200° Celsius.

Therefore, when the droplet Fb is discharged at the predetermined timing (the discharging interval timing) while reciprocating in the arrow X direction, drying of the droplet Fb that has struck the green sheet 4G first starts immediately because the green sheet 4G is heated under the conditions described above. The droplet Fb is quickly dried.

As shown in FIG. 8B, when the droplet Fb is fixed onto the green sheet 4G, the next droplet Fb strikes a position indicated by a dashed line in FIG. 8C and is arrayed such as to partially overlap with the fixed droplet Fb. At this time, the preceding droplet Fb that is fixed is not pulled towards the next droplet Fb that has struck the green sheet 4G and is arrayed such as to partially overlap with the preceding droplet Fb. The drying of the next droplet Fb that has struck the green sheet 4G and is arrayed such as to partially overlap with the preceding droplet Fb starts immediately because the green sheet 4G is heated. The portion of the next droplet Fb that does not overlap with the preceding droplet Fb is quickly dried and fixed. Thus, the next droplet Fb is not pulled towards the preceding droplet Fb.

As a result, the droplets Fb successively striking impact positions used to form the internal wiring 6 by the discharging head 30 moving in the arrow X direction are dried without shifting from the impact position. Therefore, a wiring pattern P used to form the internal wiring 6, such as that shown in FIG. 8D, is formed. Moreover, because the green sheet 4G is heated, the droplet Fb that has struck is quickly dried and fixed. Therefore, the discharging timing of the next droplet Fb to strike can be shortened. The wiring pattern P used to form the internal wiring 6 can be formed within a short period of time. Furthermore, the heating temperature of the green sheet 4G is regulated to a temperature less than the boiling point of the droplet Fb. Therefore, bumping of the droplet Fb that has struck does not occur, and the wiring pattern P can be formed.

When the discharging head 30 completes scanning from one edge of the green sheet 4G to the other, or in other words, when the discharging head 30 scans (reciprocates) in the arrow X direction and a first droplet Fb operation is completed, the controlling device 50 drives the Y-axis motor MY, via the Y-axis motor drive circuit. The controlling device 50 carries the stage 23 in the arrow Y direction by a predetermined amount, such that the droplet Fb is discharged onto a new position on the green sheet 4G to form the internal wiring 6. The controlling device 50 then enables the discharging head 30 to scan (reciprocate) in the counter-arrow X direction.

When the discharging head 30 scan (reciprocation) is started, the controlling device 50 drives and controls each piezoelectric element PZ, via the head drive circuit 54, based on the bitmap data BD as described earlier. The controlling device 50 enables the droplet Fb to be discharged from a selected nozzle N every time the discharging head 30 is positioned over an impact position used to form the internal wiring 6. In this case as well, as described earlier, the drying of the droplet Fb that has struck the green sheet 4G first starts immediately because the green sheet 4G is heated. The droplet Fb is quickly dried. When the droplet Fb is fixed onto the green sheet 4G, the next droplet Fb strikes and is arrayed such as to partially overlap with the fixed droplet Fb.

Subsequently, operations are repeated in which the discharging head 30 reciprocates in the arrow X direction and the counter-arrow X direction, the stage 23 is carried in the arrow Y direction, and the droplets Fb are discharged at a timing based on the bitmap data while the discharging head 30 reciprocates. As a result, the wiring pattern P used to form the internal wiring 6 using the droplets Fb that have struck is drawn on the green sheet 4G.

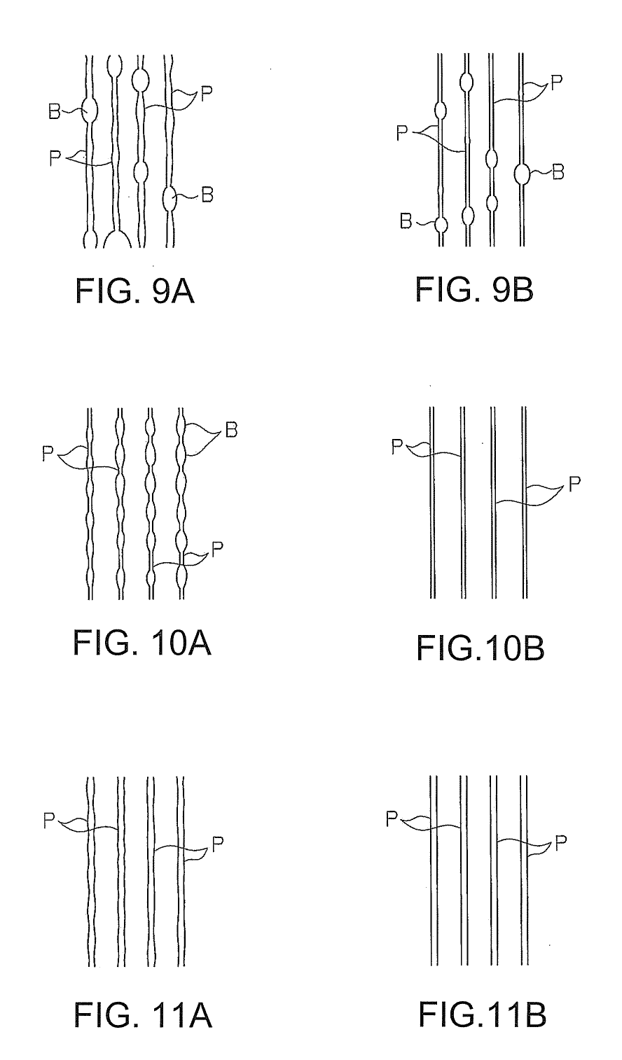

An experiment was conducted to form the wiring pattern P on a glass substrate. The experiment was conducted with changes made to conditions such as the temperature of the glass substrate and the discharging interval time. The metallic ink F was silver (Ag) particles dispersed in a solvent composed of tetradecane (boiling point of 253° Celsius). The droplet weight of the droplet Fb per droplet was 5 nanograms. FIG. 9, FIG. 10, and FIG. 11 are diagrams of each wiring pattern P acquired when conditions such as the temperature of the glass substrate and the discharging interval time are changed.

FIG. 9A shows the wiring pattern P when the glass substrate is at a room temperature of 27° Celsius and the discharging interval time is 450 microseconds. FIG. 9B shows the wiring pattern P when the glass substrate is at a room temperature of 27° Celsius and the discharging interval time is 550 microseconds. In both cases, a bulge B was formed in the wiring pattern P and a detailed pattern could not be achieved. This is because, when the glass substrate is at a room temperature of 27° Celsius, 3000 microseconds are required for the droplet Fb to become fixed. Therefore, attraction between the droplets Fb is generated and the metallic ink F is concentrates at one droplet Fb.

FIG. 10A shows the wiring pattern P when the temperature of the glass substrate is 150° Celsius and the discharging interval time is 450 microseconds. FIG. 10B shows the wiring pattern P when the temperature of the glass substrate is 150° Celsius and the discharging interval time is 550 microseconds. As shown in FIG. 10A, when the temperature of the glass substrate is 150° Celsius and the discharging interval time is 450 microseconds, 495 microseconds are required for the droplet Fb to become fixed. Therefore, a bulge B was formed in the wiring pattern P and a detailed pattern could not be achieved. As shown in FIG. 10B, when the temperature of the glass substrate is 150° Celsius and the discharging interval time is 550 microseconds, a bulge B is not formed. A high-resolution wiring pattern P can be achieved.

FIG. 11A shows the wiring pattern P when the temperature of the glass substrate is 200° Celsius and the discharging interval time is 450 microseconds. FIG. 11B shows the wiring pattern P when the temperature of the glass substrate is 200° Celsius and the discharging interval time is 550 microseconds. In both cases, a bulge B was not formed in the wiring pattern P. This is because, when the temperature of the glass substrate is 200° Celsius, 300 microseconds are required for the droplet Fb to become fixed. In both cases, the droplet Fb is already fixed. Therefore, a high-resolution pattern without a bulge B can be achieved.

The time required to form a 200-centimeter pattern in which a bulge B is not formed, under the temperature condition of each of the three substrates described above, is as follows.

When the droplets Fb are arrayed with a distance of 20 micrometers between the droplets Fb, the droplet Fb is required to be discharged 100,000 times. The time required for the droplet Fb to become fixed is 300 microseconds when the substrate is at room temperature (27° Celsius). The required time is 495 microseconds when the substrate is 150° Celsius. The required time is 330 microseconds when the substrate is 200° Celsius.

The time required to form the 200-centimeter pattern in which a bulge B is not formed is 300 seconds (=100,000×3000 μsec) when the substrate is at room temperature (27° Celsius). The required time is 49.5 seconds (=100,000×495 μsec) when the substrate is 150° Celsius. The required time is 30 seconds (−100,000×330 μsec) when the substrate is 200° Celsius.

Therefore, it is clear that pattern formation speed increases the closer the temperature of the substrate is to the boiling point of tetradecane.

An experiment was also conducted to form the wiring pattern P on a glass substrate with changes made to the temperature of the glass substrate, in which the metallic ink F is silver (Ag) particles dispersed in an aqueous solvent composed of 40 percent water, 40 percent ethylene glycol, and 30 percent polyethylene glycol.

When the temperature of the glass substrate was 80° Celsius and 100° Celsius, the water did not bump and a uniform wiring pattern P was acquired.

When the temperature of the green sheet 4G was 120° Celsius, the water bumped and an uneven, partially broken wiring pattern P was formed.

When the temperature of the glass substrate was 20° Celsius, 40° Celsius, and 60° Celsius, bumping did not occur. The droplet Fb, however, was not fixed. Therefore, the force of attraction between the droplets Fb remained strong, causing localized concentration of the functional fluid. The wiring pattern P could not be formed. In other words, the pattern P could not be formed as the temperature decreased.

Next, advantageous effects according to the embodiment configured as described above will be described.

(1) According to the embodiment, the green sheet 4G is heated to a temperature equal to or more than the temperature of the metallic ink F when the metallic ink F is discharged from the discharging head 30. Therefore, the droplet Fb that has struck the green sheet 4G is quickly heated and dried. As a result, the discharging timing of the next droplet Fb to strike can be shortened. The wiring pattern P can be formed within a short period of time.

(2) According to the embodiment, the heating temperature of the green sheet 4G is regulated at a temperature less than the boiling point of the droplet Fb. Therefore, bumping of the droplet Fb that has struck does not occur. As a result, a high-density and high-resolution wiring pattern P can be formed.

(3) According to the embodiment, when the droplet Fb that has struck the green sheet 4G first is fixed, the next droplet Fb strikes and is arrayed such as to partially overlap with the preceding droplet Fb. As a result, the fixed preceding droplet Fb is not pulled towards the next droplet Fb that has struck and is arrayed such as to partially overlap with the preceding droplet Fb. A high-density and high-resolution wiring pattern P can be formed.

(4) According to the embodiment, the rubber heater H heats the green sheet 4G such that the entire upper surface of the green sheet 4G uniformly becomes the predetermined temperature. As a result, the droplet Fb that has struck the green sheet 4G and is arrayed on the green sheet 4G evaporates from the outer periphery. The concentration of solid matter (particles) in the outer periphery reaches a saturated concentration more rapidly, compared to the center. The droplet Fb stops spreading along the surface direction of the green sheet 4G. In other words, the outer shape at the time of impact of the droplet Fb that has struck and is arrayed does not change because the droplet Fb becomes fixed from the outer periphery. As a result, a high-density and high-resolution wiring pattern P can be formed.

(5) According to the embodiment, the time required for the droplet Fb that has struck the green sheet 4G to become fixed is determined in advance. The droplets Fb are discharged with the determined time as the discharging interval time. Therefore, the next droplet can be discharged after the droplet Fb has become fixed with certainty.

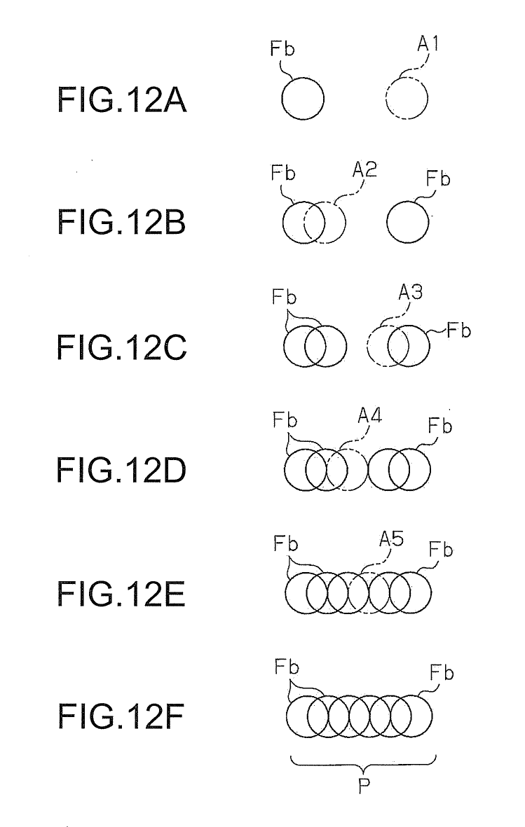

Following changes can be made to the embodiment.
According to the embodiment, when the droplet Fb strikes the green sheet 4G and is arrayed such as to partially overlap with the preceding droplet Fb, the droplet Fb strikes and is disposed after the preceding droplet Fb is fixed onto the green sheet 4G. However, the droplet Fb can strike and be arrayed before the preceding droplet Fb is fixed onto the green sheet 4G.
According to the embodiment, the next droplet Fb strikes the green sheet 4G and is arrayed such as to partially overlap with the preceding droplet Fb. However, the next droplet Fb can strike and be arrayed such as to not partially overlap with the preceding droplet Fb.
According to the embodiment, a first droplet Fb for fixing overlaps with the droplet Fb that has struck first such as to overlap by a pitch that is half of the impact diameter. However, when the droplets Fb are partially overlapping, the amount by which the droplets Fb overlap can be changed accordingly.
According to the embodiment, the wiring pattern P is formed such that the droplets Fb strike the green sheet 4G and are arrayed such as to partially overlap with successively discharged droplets Fb in sequence. For example, the wiring pattern P can be formed by the droplets Fb being discharged in a sequence such as that shown in FIG. 12A to FIG. 12F.

In other words, as shown in FIG. 12A, when the preceding droplet Fb strikes the green sheet 4G and is disposed at the predetermined position to form the pattern, the next droplet Fb strikes the green sheet 4G and is disposed at an impact position A1, indicated by a dashed line, away from the droplet Fb that has struck. When the droplet Fb is disposed at the impact position A1, the next droplet Fb to be discharged strikes and is disposed at an impact position A2, indicated by a dashed line in FIG. 12B, such as to partially overlap with the droplet Fb disposed first.

When the droplet Fb is disposed at the impact position A2, the next droplet Fb to be discharged strikes and is disposed at an impact position A3, indicated by a dashed line in FIG. 12C, such as to partially overlap with the droplet Fb disposed at the impact position A2. Subsequently, the droplets Fb similarly strike and are disposed at impact positions A4 and A5 in the order shown in FIG. 12D and FIG. 12E. As a result, the wiring pattern P for the internal wiring 6 formed using the droplets Fb, such as that shown in FIG. 12F, can be drawn.
According to the embodiment, the functional fluid is realized by the metallic ink F. The functional fluid is not limited thereto and, for example, can be a functional fluid including liquid crystal material. In other words, the functional fluid is only required to be that which can be discharged to form the pattern.
According to the embodiment, a base substrate is realized by a wiring pattern formed on the green sheet 4G that is the low-temperature fired substrates 4 forming the LTCC multilayer substrate 2. The base substrate is not limited thereto and, for example, a pattern can be formed using the droplet discharging device on other substrates such as glass.
According to the embodiment, the heating temperature of the green sheet 4G is set to a temperature that is less than the lowest boiling point temperature among the various liquid compositions included in the metallic ink F. However, when the liquid composition with the lowest boiling point temperature has a low concentration that does not affect the shape of the pattern when bumping of the liquid composition occurs, the lowest boiling point temperature can be ignored. The lowest boiling point temperature from among the liquid compositions with a concentration high enough to affect the pattern formation by bumping is selected. The heating temperature of the green sheet 4G is less than the selected temperature. As a result, the droplet Fb can be dried more optimally and more efficiently.
According to the embodiment, a droplet discharging means is realized by the piezoelectric element-driven droplet discharging head 30. The droplet discharging means is not limited thereto. The droplet discharging head can be a resistance heating type discharging head or an electrostatic-driven discharging head.

The entire disclosure of Japanese Patent Application No. 2006-321257, filed Nov. 29, 2006 is expressly incorporated by reference herein.

What is claimed is:

1. A pattern forming method that successively discharges droplets of a functional fluid including a functional material towards a base substrate and forms a pattern on a surface of the base substrate, the pattern forming method comprising:
heating a surface of the base substrate to a surface temperature equal to or more than a temperature of the functional fluid during discharging and less than a boiling point of a liquid composition included in the functional fluid; and
discharging the droplets of the functional fluid onto the base substrate and forming a pattern under the condition when the base substrate is heated to the surface temperature.

2. The pattern forming method according to claim 1, wherein,
when heating the surface of the base substrate, the base substrate is heated to a surface temperature at which a concentration of solid matter (particles) in an outer periphery of the droplet that has struck the base substrate reaches a saturated concentration more quickly, compared to a center of the droplet.

3. The pattern forming method according to claim 1, wherein,
the pattern formed is formed by droplets being discharged such that adjacent droplets that have struck the base substrate at least partially overlap with each other.

4. The pattern forming method according to claim 1, wherein,
when a droplet is discharged such as to partially overlap with a droplet that has struck the base substrate first, the droplet is discharged after an outer diameter of the droplet that has struck the base substrate first stops changing.

5. The pattern forming method according to claim 1, wherein,
when discharging the droplets of the functional fluid onto the base substrate and forming the pattern, a time required until the outer diameter of the droplet that has struck stops changing, for the surface temperature, is determined in advance, the determined time serves as a discharging interval time of the droplets, and the droplets are successively discharged at an interval greater than the discharging interval time.

6. The pattern forming method according to claim 1, wherein:
the base substrate is a low-temperature firing sheet composed of ceramic particles and resin; and
the functional fluid is a liquid in which metal particles are dispersed as functional material.

7. The pattern forming method according to claim 1, wherein,
the boiling point of the liquid composition included in the functional fluid is a boiling point of a liquid composition with a lowest boiling point among the liquid compositions.

8. The pattern forming method according to claim 1, wherein,
the boiling point of the liquid composition included in the functional fluid is a boiling point of a liquid composition with a lowest boiling point among liquid compositions having a concentration that affects pattern formation when bumping occurs.

9. A circuit board on which a circuit element is mounted and wiring electrically connected to the mounted circuit element is formed, wherein,
the wiring is formed using the pattern forming method according to claim 1.
